(19) United States
(12) Patent Application Publication
(10) Pub. No.: US 2016/0291284 A1
(43) Pub. Date: Oct. 6, 2016

(54) LENS-DRIVING DEVICE

(71) Applicant: NIDEC COPAL CORPORATION, Tokyo (JP)

(72) Inventors: Hiroyuki WATANABE, Tokyo (JP); Haruhiko MANDAI, Tokyo (JP); Kazuya ATSUTA, Tokyo (JP)

(73) Assignee: Nidec Copal Corporation, Tokyo (JP)

(21) Appl. No.: 15/038,315

(22) PCT Filed: Dec. 26, 2014
(86) PCT No.: PCT/JP2014/084506

§ 371 Date: May 20, 2016

(30) Foreign Application Priority Data
Dec. 27, 2013 (JP) 2013-272685

(51) Int. Cl. G02B 7/04; H04N 5/225; H02K 41/035; G02B 27/64

(52) U.S. Cl. CPC G02B 7/04; G02B 27/648; H04N 5/2254; H04N 5/2257; H02K 41/0356

(57) ABSTRACT

A lens-driving device includes a lens frame; a base member; a support that supports the lens frame such that the lens frame can move, relative to the base member, along the optical axis; a driving means that drives the lens frame along the optical axis; and a focus control unit that controls the driving means so as to move the lens frame to a focus position. The support has an elastic support member that supports the lens frame in a suspended manner in an elastic equilibrium position when the driving means is powered off. To set a focus baseline, the focus control unit controls the driving means so as to make the lens frame abut against a mechanical focus baseline position.

### CROSS-REFERENCE TO RELATED APPLICATIONS

This application is a U.S. National Phase Application under 35 U.S.C. §371 of International Patent Application PCT/JP2014/084506, filed Dec. 26, 2014, which claims priority to Japanese Patent Application No. 2013-272685, filed Dec. 27, 2013. The entire contents of these applications are hereby incorporated by reference.

### FIELD OF TECHNOLOGY

The present disclosure relates to a lens driving device.

### BACKGROUND

In a known lens driving device of an electromagnetic driving approach, a coil and a magnet are provided as a driving portion (referencing Japanese Unexamined Patent Application Publication 2007-139810). In this lens driving device, a spring member is used to support a lens frame elastically along the optical axial direction, and the optical axial direction position of the lens frame is adjusted variably to a position wherein the driving force of a driving portion (an electromagnetic actuator) and the elastic force of the spring member are in equilibrium.

There are known lens driving devices of this type wherein a lens frame is held by a base member near the focal plane by the biasing force of a spring member when no current of the driving portion is applied, and those wherein the lens frame is held in a suspended state at the equilibrium position of a pair of spring members.

In the former case, the lens frame can be held relatively stably, but there has been a problem in that a tilt (an initial tilt) is produced in the optical axis at the initial position for driving the lens frame due to the machining precision of the holding face of the base member, preventing desired lens driving performance when this initial tilt is produced. Moreover, when no current is applied, the position wherein the lens frame is held is further toward the focal plane side from the infinitely far position, and thus, when adjusting the focus, the lens frame must be moved to the focus position from there, so there is a problem in that the distance of travel when adjusting the focus is too long.

In contrast, in the latter case, the lens frame is held in advance within the range over which the focus may be adjusted, thus making it possible to reduce the distance of travel when adjusting the focus, and it is possible to control the initial tilt by the component accuracy of the spring members alone, rather than the initial tilt being affected by the machining precision of the base member. However, because the lens frame is not held with stability when no current is applied, there is a problem in that it is difficult to set a adjusting the focus reference position at a stabilized position.

### SUMMARY

In the present invention, the handling of such problems is an example of the problem to be solved. That is, objects of the present invention are to be able to reduce the distance of travel when adjusting the focus, to facilitate control of the initial tilt, to set the reference position for adjusting the focus at a stabilized position, and the like.

To achieve such objects, the lens driving device according to the present invention is provided with the following structures, in the several inventions set forth in the Specification: a lens driving device comprising a lens frame, a base member, a supporting portion for supporting the lens frame movably, in the optical axial direction, relative to the base member, a driving member for driving the lens frame in the optical axial direction, and a focus controlling portion for controlling the driving portion so as to adjust the lens frame to a focus position, wherein: the supporting portion comprises an elastic supporting member for supporting the lens frame in a suspended state in an elastic equilibrium position when no current of the driving portion is applied; and the focus controlling portion, at the time of setting a focus reference, controls the driving portion to cause the lens frame to contact a mechanical focus reference position.

### BRIEF DESCRIPTION OF THE DRAWINGS

FIG. 1 (a) is an explanatory diagram illustrating schematically the basic structure of a lens driving device according to one example according to the present invention wherein the driving portion applies no current.

FIG. 1 (b1) is an explanatory diagram illustrating schematically the basic structure of a lens driving device according to one example according to the present invention when setting the focus reference.

FIG. 1 (b2) is another explanatory diagram illustrating schematically the basic structure of a lens driving device according to one example according to the present invention when setting the focus reference.

FIG. 2 is an exploded explanatory diagram (an assembly perspective diagram) illustrating a specific example configuration of a lens driving device according to an example according to the present invention.

FIG. 3 is an explanatory diagram illustrating a specific example configuration of a lens driving device according to an example according to the present invention.

FIG. 4 is an explanatory diagram (an overall perspective diagram) illustrating a specific example configuration of a lens driving device according to an example according to the present invention.

FIG. 5 is an explanatory diagram (an overall plan view) illustrating a specific example configuration of a lens driving device according to an example according to the present invention.

FIG. 6 (a) is a cross-sectional view along the section A-A in FIG. 5 illustrating a specific example configuration of a lens driving device according to an example according to the present invention.

FIG. 6 (b) is a cross-sectional view along the section B-B in FIG. 5 illustrating a specific example configuration of a lens driving device according to an example according to the present invention.

FIG. 7 (a) is a cross-sectional views along the section B-B in FIG. 5 illustrating a specific example configuration of a lens driving device according to an example according to the present invention.

FIG. 7 (b) is another cross-sectional view along the section B-B in FIG. 5 illustrating a specific example configuration of a lens driving device according to an example according to the present invention.

FIG. 8 is an explanatory diagram illustrating a camera module and an electronic device that use the lens driving device according to an example according to the present invention.

### DETAILED DESCRIPTION OF THE INVENTION

A lens driving apparatus according to an example according to the present invention comprises: a lens frame; a base member; a supporting portion for supporting a lens frame, relative to a base member, so as to enable movement in the optical axial direction; a driving portion for driving the lens frame in the optical axial direction; and a focus controlling portion for controlling the driving portion so as to adjust the lens frame to a focus position. The supporting portion is provided with an elastic supporting member for supporting the lens frame in a suspended state at an elastic equilibrium position when no current of the driving portion is applied. The focus controlling portion is provided with a controlling function for controlling the driving portion to cause the lens frame to contact a focus reference position mechanically when setting the focus reference.

Given such a lens driving device, when no driving portion current is applied, the lens frame is supported in a suspended state at the equilibrium position within the focus adjusting range, enabling a reduction in the distance of travel when adjusting the focus. Moreover, because the lens frame is not held against the base member when no current is applied, there is no effect by the precision with which the base member is machined, enabling control of the initial tilt. Because the lens frame contacts the focus reference position when setting the focus reference, the reference position for adjusting the focus can be set to a stabilized position.

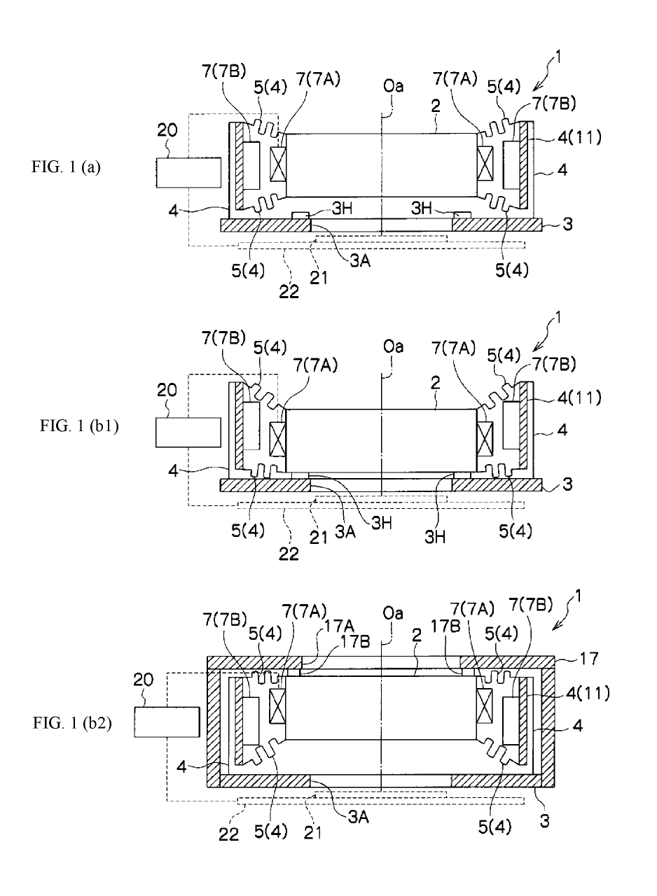

An example according to the present invention will be explained below in reference to the drawings. FIG. 1 is an explanatory diagram illustrating schematically the basic structure of a lens driving device according to one example according to the present invention. (a) illustrates a state wherein the driving portion applies no current, and (b1) and (b2) illustrate the state when setting the focus reference.

The lens driving device 1 is equipped with a lens frame 2, a base member 3, a supporting portion 4, a driving portion 7, and a focus controlling portion 20. The lens frame 2 is equipped with a lens barrel (not shown) having an optical axis Oa. The base member 3 supports the lens frame 2 through the supporting portion 4, and is provided with an opening 3A corresponding to the optical path of the lens frame 2. The supporting portion 4 supports the lens frame 2, relative to the base member 3, so as to enable movement in the direction of the optical axis Oa, and is provided with an elastic supporting member 5 for supporting the lens frame 2 elastically along the optical axis Oa. The driving portion 7 is provided with, for example, a coil 7A and a magnet 7B that structure an electromagnetic actuator for driving the lens frame 2 in the direction of the optical axis Oa. While the example that is illustrated is of a movable coil type wherein a coil 7A is secured to the lens frame 2 and a magnet 7B is secured to an annular yoke 11 that surrounds the lens frame 2, and is part of the supporting portion 4, it may instead be of a movable magnet-type wherein the magnet 7B is secured to the lens frame 2 and the coil 7A is secured to the supporting portion 4.

The focus controlling portion 20 is that which controls the driving portion 7 so as to adjust the lens frame 2 to the focus position, and controls driving of the lens frame 2 so that the focal plane of the lens installed in the lens frame 2 will be on the photosensitive surface of the imaging element 21. This focus controlling portion 20 may be structured through a controlling circuit 22 that outputs a focus controlling signal depending on an image signal that is outputted from the imaging element 21, for example.

As illustrated in FIG. 1, when no current of the driving portion 7 is applied in such a lens driving device 1, the elastic supporting member 5 supports the lens frame 2 in a suspended state at the elastic equilibrium position, where this equilibrium position is a position within the focus adjusting range of the lens frame 2. When no current of the driving portion 7 is applied, the elastic supporting member 5 supports the lens frame 2 in a suspended state, which is a state wherein the lens frame 2 is pulled in opposite directions or pushed in opposite directions, at one end thereof and the other end thereof, in the optical axial direction. When adjusting the focus, power is supplied to the driving portion 7 depending on an output of the focus controlling portion 20, to move the lens frame 2 from this equilibrium position to the focus adjustment position, so that the lens frame 2 will be held in an equilibrium between the driving force of the driving portion 7 and the elastic forces of the elastic supporting members 5.

In contrast, a function is provided whereby, when setting the focus reference, which is carried out during setup in the manufacturing process in the factory, or when setting the default settings prior to adjusting the focus, or at other times, the focus controlling portion 20 applies, to the driving portion 7, a current that is larger than when adjusting the focus, to cause the lens frame 2 to contact the focus reference position mechanically. FIG. 1 (b1) illustrates an example when setting the focus reference, where the mechanical focus reference position is set at contacting portions 3H on the base member 3. In this case, the maximum current is applied to the driving portion 7 by the output of the focus controlling portion 20, so that the lens frame 2 will contact the contacting portions 3H on the base member 3, which is outside of the range over which the focus can be adjusted. FIG. 1 (b2) illustrates another example when setting the focus reference. In this example, the lens driving device 1 is provided with a cover member 17 that covers the lens frame 2 and the supporting portion 4, where the mechanical focus position is set at the inner surface side of the cover member 17. In this case, a maximum current is applied to the driving portion 7 by the output of the focus controlling portion 20 in the opposite direction from that of the case in FIG. 1 (b1), causing the lens frame 2 to contact contacting portions 17B on the inner surface side of the cover member 17, which is outside of the range over which the focus can be adjusted.

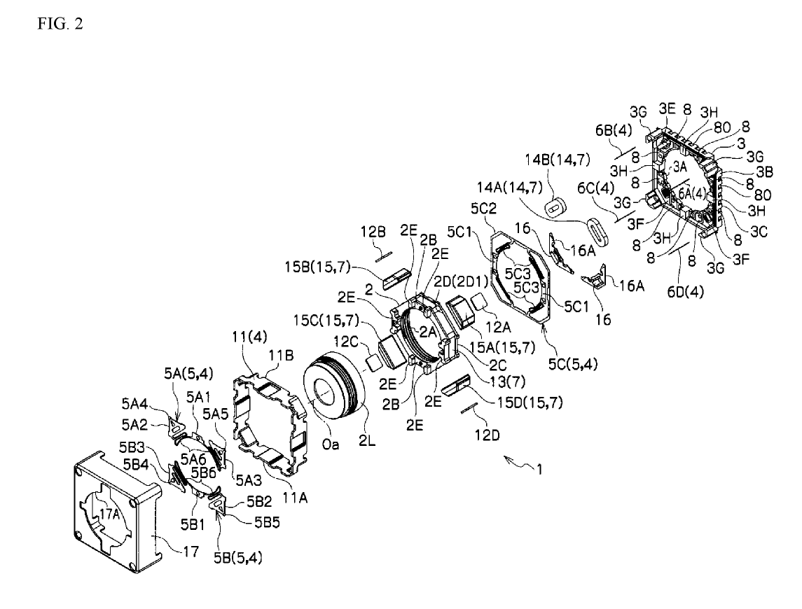

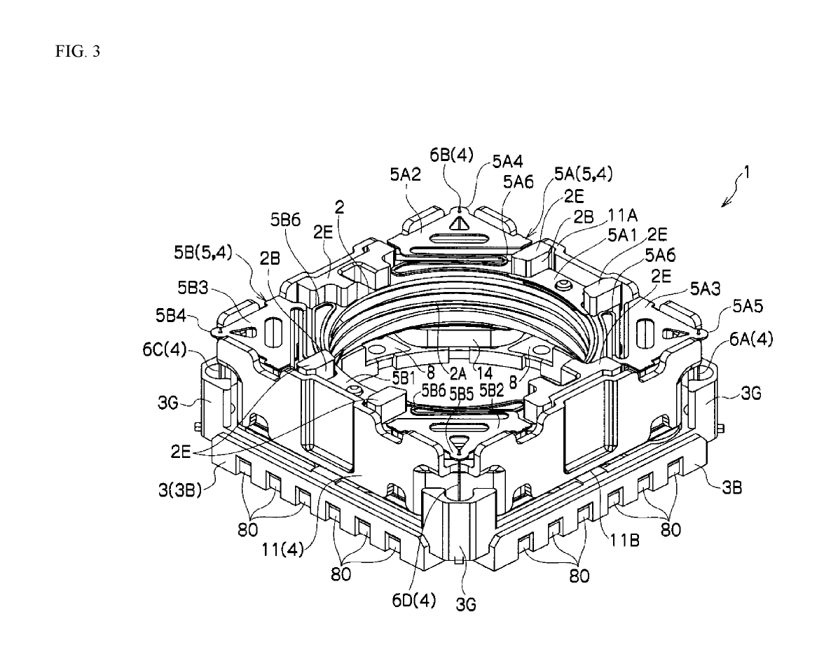

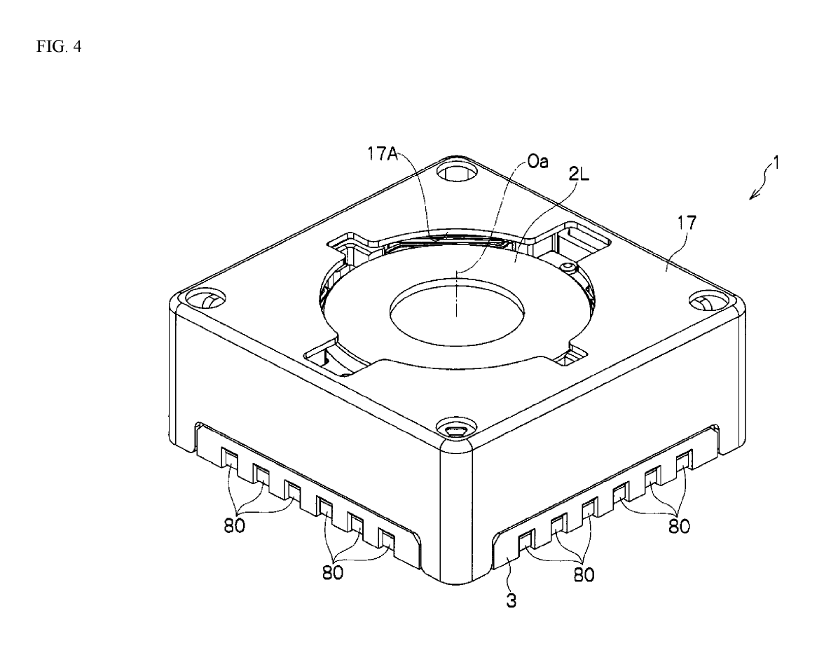

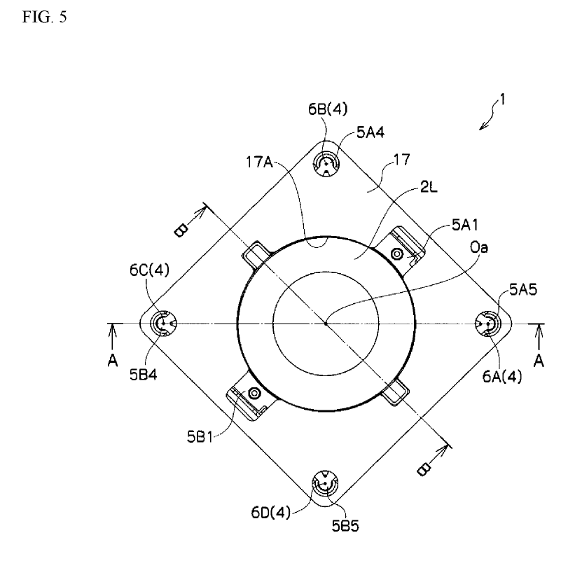

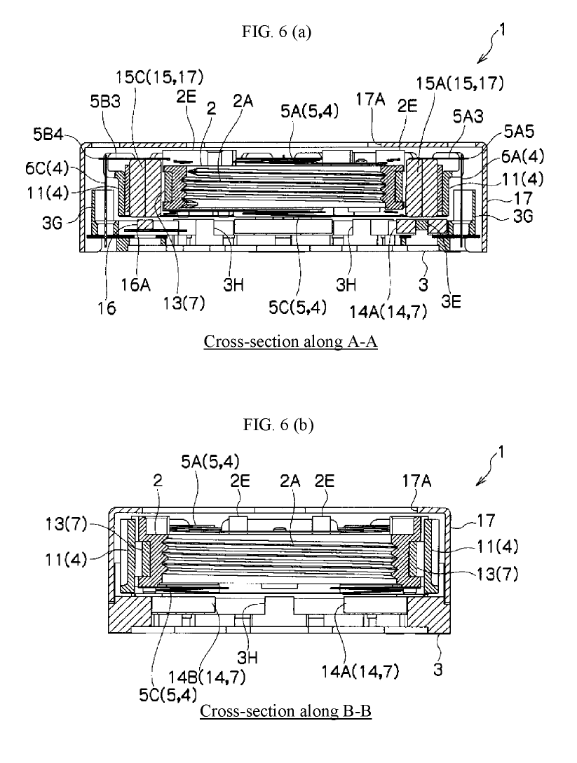

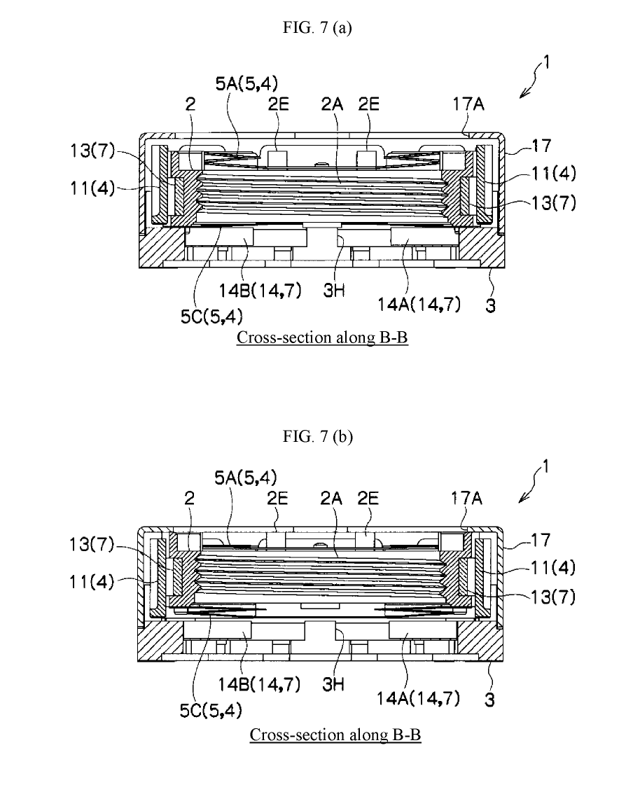

FIG. 2 through FIG. 7 illustrate other specific example configurations of the lens driving device according to examples according to the present invention. FIG. 2 is an assembly perspective diagram; FIG. 3 is a critical portion perspective diagram (in the state wherein the cover member has been removed); FIG. 4 is an overall perspective diagram (in the state wherein the cover member is attached); FIG. 5 is an overall plan view (in the state wherein the cover member is attached); FIG. 6 (a) is a cross-sectional view along the section A-A in FIG. 5, and (b) is a cross-sectional view along the section B-B in FIG. 5; and FIGS. 7 (a) and (b) are cross-sectional views along the section B-B in FIG. 5.

As described above, the lens driving device 1 in this specific example also comprises a lens frame 2, a base member 3, a supporting portion 4, and a driving portion 7. A lens frame 2 that is provided with a lens attaching opening 2A, to which the lens barrel 2L is attached, is provided with a top end attaching portion 2B on one end side along the optical axis Oa and a bottom end attaching portion 2C on the other end side. Moreover, a coil retaining portion 2D1 is provided on a side face 2D of the lens frame 2. The lens frame 2 is supported on the base member 3 through the supporting portion 4.

The supporting portion 4 is structured from an annular yoke 11, an elastic supporting member 5, and wire supports 6A through 6D. The annular yoke 11 is a magnetic material that encompasses the periphery of the lens frame 2, and, in the example that is illustrated, is structured from a rectangular frame member, where the magnets 15 (15A, 15B, 15C, and 15D), which are structural elements of the driving portion 7, are attached to the four corners thereof. Note that the annular yoke 11 is illustrated in a ring-shape and the term “annular” is not limited to an approximately square or rectangular inner perimeter but can be circular or any other shape that can “loop” or close on itself.

The elastic supporting member 5 supports the lens frame 2, relative to the annular yoke 11, elastically along the optical axial direction, and, in the example that is illustrated, is structured from top leaf springs 5A and 5B that are attached between the top end attaching portion 2B of the lens frame 2 and a top edge 11A of the annular yoke 11, and a bottom leaf spring 5C that is attached between the bottom end attaching portion 2C of the lens frame 2 and a bottom edge 11B of the annular yoke 11. The top leaf springs 5A and 5B and the bottom leaf spring 5C support the lens frame 2 in a suspended state, in a state wherein one end thereof and the other end thereof are pulled in opposite directions along the optical axial direction when no current is applied to the driving portion 7. In this example, the support is in a suspended state wherein the top leafs spring 5A and 5B and the bottom leaf spring 5C pull in mutually opposing directions, but there is no limitation thereto, and instead the support may be in a suspended state in a state wherein they push toward each other.

The top leaf springs 5A and 5B are disposed in a state wherein the members of the left/right pair are electrically insulated from each other, where the top leaf spring 5A comprises a lens frame attaching portion 5A1, annular yoke attaching portions 5A2 and 5A3, wire support attaching portions 5A4 and 5A5, and an elastically deforming portion 5A6, and the top leaf spring 5B comprises a lens frame attaching portion 5B1, annular yoke attaching portions 5B2 and 5B3, wire support attaching portions 5B4 and 5B5, and an elastically deforming portion 5B6. The lens frame attaching portions 5A1 and 5B1 of the top leaf springs 5A and 5B are attached to top end attaching portions 2B of the lens frame 2, where the annular yoke attaching portions 5A2, 5A3, 5B2, and 5B3 of the top leaf springs 5A and 5B are attached to the top edge 11A of the annular yoke 11. Moreover, the bottom leaf spring 5C comprises a pair of lens frame attaching portions 5C1, a ring-shaped annular yoke attaching portion 5C2, and an elastically deforming portion 5C3, where the lens frame attaching portion 5C1 is attached to a bottom end attaching portion 2C of the lens frame 2, and the annular yoke attaching portion 5C2 is attached to a bottom edge 11B of the annular yoke 11.

The plurality of wire supports 6A, 6B, 6C, and 6D elastically support the annular yoke 11 relative to the base member 3 in directions that are perpendicular to the optical axis, where the top end portions thereof are attached to the wire support attaching portions 5A4, 5A5, 5B4, and 5B5 of the top leaf springs 5A and 5B, which are attached to the annular yoke 11, and the bottom end portions thereof are attached within holding frames 3G that are provided at the four corners of the base member 3. The wire supports 6A, 6B, 6C, and 6D support the lens frame 2, the annular yoke 11, and the elastic supporting member 5 in a suspended state above the base member 3, where the elastic flexure of the wire supports 6A, 6B, 6C, and 6D enables movement of the lens frame 2 or the annular yoke 11 in the directions that are perpendicular to the optical axis Oa.

The driving portion 7 structures an electromagnetic actuator through a focus driving coil 13, deflection correcting coils 14 (14A and 14B) and magnets 15 (15A, 15B, 15C, and 15D). The focus driving coil 13 is coiled on the coil retaining portion 2D1 on the side face 2D of the lens frame 2, and, in conjunction with the magnets 15 (15A, 15B, 15C, and 15D) that are attached to the annular yoke 11, structure a first electromagnetic actuator for driving the lens frame 2 along the optical axis Oa. The magnets 15 (15A, 15B, 15C, and 15D) have one face side that faces the lens frame 2 as either a north pole or a south pole, and the back face side thereof as the opposite pole, the south pole or the north pole, to form a magnetic path from the one face side to the back face side, passing through the focus driving coil 13. Plate-shaped yokes 12A, 12B, 12C, and 12D are disposed on the back face sides of the magnets 15 (15A, 15B, 15C, and 15D) for forming these magnetic paths.

The deflection correcting coils 14 (14A and 14B) are held respectively on two coil retaining portions 3E in the base member 3, and, in conjunction with the magnets 15 (15A and 15B) that are attached to the annular yoke 11, structure second electromagnetic actuators for driving the lens frame 2 in directions that are perpendicular to the optical axis Oa. The deflection correcting coils 14A and 14B are wound in the form of ovals that have pairs of straight portions, having straight portions that extend in mutually differing directions within a plane that is perpendicular to the optical axis Oa. Given this, the magnets 15 (15A and 15B) form magnetic paths that cut across one of the straight portions of the deflection correcting coils 14 (14A and 14B) from one of the poles thereof, along the optical axial direction, and cut across the other of the straight portions, in the opposite direction, to return to the other pole.

The base member 3 is provided with a plurality of connecting terminals 8 at the periphery of the opening 3A that faces the lens attaching opening 2A of the lens frame 2. In the example that is illustrated, the base member 3 is formed in a rectangular shape corresponding to the annular yoke 11, and holding frames 3G for holding the wire supports 6A, 6B, 6C, and 6D are formed on the four corners thereof. Moreover, on the surfaces that face the annular yoke 11, Hall element retaining portions 3F are provided together with the aforementioned coil retaining portions 3E, and, additionally, contacting portions 3H for contacting the bottom end of the lens frame 2 are also provided. Hall elements (position detecting elements) 16, which are mounted on circuit board 16A are provided at the respective Hall element retaining portions 3F at two locations. The two Hall elements 16 face in mutually differing directions within a plane that crosses the optical axis Oa, and are disposed facing the magnets 15C and 15D that are attached to the annular yoke 11.

A plurality of connecting terminals 8, disposed on the base member 3, is structured through embedded molding (insert molding), using a resin material, or the like, independently in the base member 3, with a portion thereof exposed on the lens frame 2 side and another portion thereof exposed on the side face 3B or back face 3C of the base member 3, to structure an external connecting face 80. The deflection correcting coils 14A and 14B, and the hall elements 16 for detecting the position of the lens frame 2, on the base member 3, are connected to the plurality of connecting terminals 8. Moreover, the wire supports 6A and 6D form a power supply path, where the end portions thereof are connected to connecting terminals 8 within the holding frames 3G, where a power supply path is formed from the wire supports 6A and 6D through the top leaf springs 5A and 5B, arriving at the focus driving coil 13. A power supply and a controlling circuit, not shown, are connected to the external connecting faces 80 of the connecting terminals 8, provided on the base member 3.

The lens driving device 1 is provided with a cover member 17 for covering the lens frame 2, the supporting portion 4, and the driving portion 7, where covering the driving portion 7 with the cover member 17, which has an electromagnetic shielding function, suppresses electromagnetic noise that leaks to the outside from the driving portion 7. This cover member 17 is provided with an opening 17A enabling light to be received into the lens barrel 2L, where the periphery of the opening 17A serves as a ceiling portion (a contacting portion) relative to the top end of the lens frame 2.

The focus controlling function of the lens driving device 1 will be explained in reference to FIG. 6 and FIG. 7. In the lens driving device 1, as is illustrated in FIGS. 6 (a) and (b), when no current is applied to the focus driving coil 13 in the driving portion 7, the bottom end of the lens frame 2 will be away from the contacting portion 3H of the base member 3, and the top end of the lens frame 2 (the contacting portion 2E) will be away from the inner surface of the cover member 17, so the lens frame 2 will be supported in a suspended state, at the position of elastic equilibrium of the elastic supporting members 5 (the top leaf springs 5A and 5B, and the bottom leaf spring 5C). In this state, when a prescribed current is supplied to the focus driving coil 13 through a focus adjusting output of a focus controlling portion, not shown, the lens frame 2 will be held in a focus position wherein the driving force of the driving portion 7 and the elastic forces of the elastic supporting members 5 are in equilibrium. At this time, the focus adjustment can be performed quickly, with a small distance of travel, because, prior to adjusting the focus, the support will be in a suspended state with the position of the lens frame 2, within the focus adjusting range.

In contrast, when setting the focus reference, which is carried out in the setup in the manufacturing process in the factory, or carried out when setting the default settings, performed prior to adjusting the focus, or at some other time, a maximum current is supplied to the driving portion 7, outside of the range over which the focus can be adjusted, by the output of the focus controlling portion, not shown. This produces a state wherein, as illustrated in FIG. 7 (a), the bottom end of the lens frame 2 is in contact with the contacting portions 3H of the base member 3. Causing the lens frame 2 to contact the contacting portions 3H in this way produces a state wherein the lens frame 2 is held against a mechanical focus reference position. This enables setting of a stabilized reference value through setting or correcting, in this state, the reference value in the focus controlling portion.

In the example illustrated in FIG. 7 (b), the contacting portions 2E at the top end of the lens frame 2 are caused to contact the inner surface of the cover member 17, to hold the lens frame 2 against a mechanical focus reference position. In this case, a maximum current is applied to the driving portion 7, in the opposite direction of that of the case in FIG. 7 (a), by the output of the focus controlling portion, not shown. Because the focus controlling portion has such a function, the lens driving device 1 is able to set and correct, with high accuracy, the reference value for adjusting the focus, making it possible to adjust the focus with high accuracy.

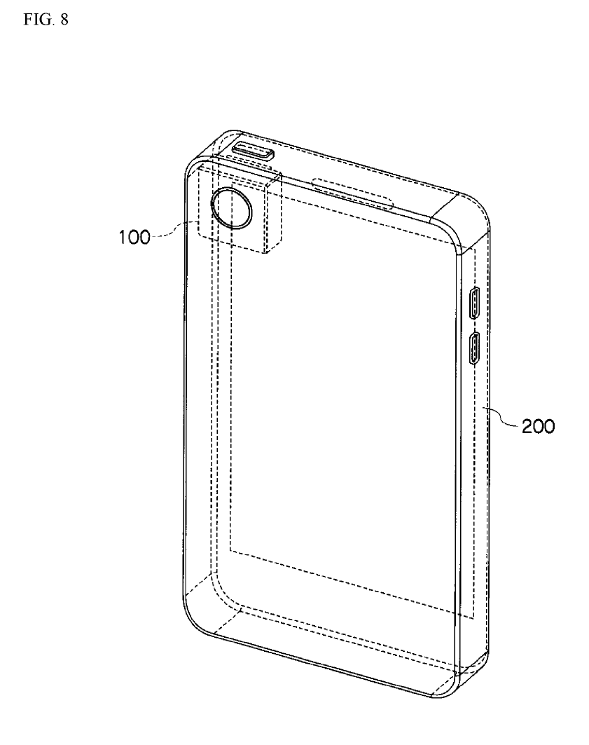

FIG. 8 illustrates an example of a camera module and an electronic device equipped with this lens driving device. As illustrated in FIG. 8, the lens driving device 1 is equipped in a camera module 100 or in an electronic device 200 (a mobile telephone, a smart phone, a tablet PC, a notebook PC, or the like) that is equipped with a camera module 100. The camera module 100 and the electronic device 200 that are provided with the lens driving device 1 enable high-performance focusing control through the distinctive features of the lens driving device 1.

While examples according to the present disclosure were described in detail above, referencing the drawings, the specific structures thereof are not limited to these examples, but rather design variations within a range that does not deviate from the spirit and intent of the present invention are also included in the present invention. Moreover, insofar as there are no particular contradictions or problems in purposes or structures, or the like, the technologies of the various examples described above may be used together in combination.

1. A lens driving device comprising:
a lens frame;
a base member;
a support supporting the lens frame movably, in the optical axial direction, relative to the base member;
a driver driving the lens frame in the optical axial direction; and
a focus controller controlling the driver so as to adjust the lens frame to a focus position,
wherein the support comprises an elastic support supporting the lens frame in a suspended state in an elastic equilibrium position when the driver does not supply a current to the support; and
wherein the focus controller, at the time of setting a focus reference, controls the driver to cause the lens frame to contact a mechanical focus reference position.

2. A lens driving device comprising:
a lens frame;
a base member;
a support supporting the lens frame movably, in the optical axial direction, relative to the base member;
a driver driving the lens frame in the optical axial direction; and
a focus controller controlling the driver so as to adjust the lens frame to a focus position,
wherein the support comprises an elastic support supporting the lens frame in a suspended state in an elastic equilibrium position when the driver does not supply a current to the support; and
wherein the focus controller controls the driver to cause the lens frame to contact a mechanical focus reference position.

3. A lens driving device as set forth in claim 2,
wherein when no driving portion current is applied, the elastic support supports the lens frame in a suspended state, in a state wherein one end and the other end thereof, in the optical axial direction, are pulled in mutually opposing directions.

4. A lens driving device as set forth in claim 2, wherein the mechanical focus reference position is provided on the base member.

5. A lens driving device as set forth in claim 2, further comprising a cover member for covering the lens frame and the support,
wherein the mechanical focus reference position is provided on the inner surface side of the cover member.

6. A camera module comprising a lens driving device as set forth in claim 2.

7. An electronic device comprising a lens driving device as set forth in claim 2.
